(19) United States
(12) Patent Application Publication
(10) Pub. No.: US 2024/0176566 A1
(43) Pub. Date: May 30, 2024

(54) PROCESSING METHOD AND APPARATUS THEREOF

(71) Applicant: Lenovo (Beijing) Limited, Beijing (CN)

(72) Inventor: Jin LIU, Beijing (CN)

(21) Appl. No.: 18/384,318

(22) Filed: Oct. 26, 2023

(30) Foreign Application Priority Data
Nov. 30, 2022 (CN) 202211527934.1

(51) Int. Cl. G06F 3/14; G06F 3/04842; G06F 3/04845; G06F 3/04847; G06F 3/0486; G06T 11/60

(52) U.S. Cl. CPC G06F 3/14; G06F 3/04842; G06F 3/04845; G06F 3/04847; G06F 3/0486; G06T 11/60; G06V 20/70

(57) ABSTRACT

A processing method includes, in response to obtaining a first operation performed on a first display region of an electronic device, generating a target processing logic based on the first operation and an initial processing logic, where the first display region displays at least one stream of multimedia data obtained by the electronic device, the first operation is configured to determine target multimedia data from the at least one stream of the multimedia data, and the initial processing logic is a processing logic executed by the electronic device to process current multimedia data before obtaining the first operation; processing the target multimedia data based on the target processing logic; and outputting target multimedia content obtained by processing the target multimedia data.

### CROSS-REFERENCE TO RELATED APPLICATION

This application claims the priority of Chinese Patent Application No. 202211527934.1, filed on Nov. 30, 2022, the content of which is incorporated herein by reference in its entirety.

### TECHNICAL FIELD

The present disclosure generally relates to the field of electronic device technology, and, more particularly, relates to a processing method and an apparatus thereof.

### BACKGROUND

In application scenarios of screen fusion of multimedia data, the problem of applying multiple algorithms to process different types of multimedia data may be solved by using different interactive interfaces to operate different types of multimedia data. However, in application scenarios where multiple interactive interfaces are operated, there may be certain problems such as unnatural interaction between multiple interfaces, high learning costs for users, and inability to use them quickly.

### SUMMARY

One aspect of the present disclosure provides a processing method. The processing method includes, in response to obtaining a first operation performed on a first display region of an electronic device, generating a target processing logic based on the first operation and an initial processing logic, where the first display region displays at least one stream of multimedia data obtained by the electronic device, the first operation is configured to determine target multimedia data from the at least one stream of the multimedia data, and the initial processing logic is a processing logic executed by the electronic device to process current multimedia data before obtaining the first operation; processing the target multimedia data based on the target processing logic; and outputting target multimedia content obtained by processing the target multimedia data.

Another aspect of the present disclosure provides an electronic device including a memory, configured to store a computer program; and a processor, coupled to the memory and when the computer program is executed, configured to: in response to obtaining a first operation performed on a first display region of an electronic device, generate a target processing logic based on the first operation and an initial processing logic, where the first display region displays at least one stream of multimedia data obtained by the electronic device, the first operation is configured to determine target multimedia data from the at least one stream of the multimedia data, and the initial processing logic is a processing logic executed by the electronic device to process current multimedia data before obtaining the first operation; process the target multimedia data based on the target processing logic; and output target multimedia content obtained by processing the target multimedia data.

Another aspect of the present disclosure provides a non-transitory computer-readable storage medium, containing a computer program for, when executed by a processor, performing: in response to obtaining a first operation performed on a first display region of an electronic device, generating a target processing logic based on the first operation and an initial processing logic, where the first display region displays at least one stream of multimedia data obtained by the electronic device, the first operation is configured to determine target multimedia data from the at least one stream of the multimedia data, and the initial processing logic is a processing logic executed by the electronic device to process current multimedia data before obtaining the first operation; processing the target multimedia data based on the target processing logic; and outputting target multimedia content obtained by processing the target multimedia data.

Other aspects of the present disclosure may be understood by those skilled in the art in light of the description, the claims, and the drawings of the present disclosure.

### BRIEF DESCRIPTION OF THE DRAWINGS

To clearly describe technical solutions of various embodiments of the present disclosure, the drawings which need to be used for describing various embodiments are described below. Obviously, the drawings in the following description are merely some embodiments of the present disclosure. For those skilled in the art, other drawings may be obtained in accordance with the drawings without creative efforts.

FIG. 1A illustrates a flowchart of a processing method according to various embodiments of the present disclosure.

FIG. 1B illustrates a schematic of an application scenario according to various embodiments of the present disclosure.

FIG. 1C illustrates another schematic of an application scenario according to various embodiments of the present disclosure.

FIG. 2A illustrates another flowchart of a processing method according to various embodiments of the present disclosure.

FIG. 2B illustrates another schematic of an application scenario according to various embodiments of the present disclosure.

FIG. 2C illustrates another schematic of an application scenario according to various embodiments of the present disclosure.

FIG. 2D illustrates another schematic of an application scenario according to various embodiments of the present disclosure.

FIG. 2E illustrates another schematic of an application scenario according to various embodiments of the present disclosure.

FIG. 2F illustrates another schematic of an application scenario according to various embodiments of the present disclosure.

FIG. 2G illustrates another schematic of an application scenario according to various embodiments of the present disclosure.

FIG. 3A illustrates another flowchart of a processing method according to various embodiments of the present disclosure.

FIG. 3B illustrates another schematic of an application scenario according to various embodiments of the present disclosure.

FIG. 3C illustrates another schematic of an application scenario according to various embodiments of the present disclosure.

FIG. 4 illustrates a structural schematic of a processing apparatus according to various embodiments of the present disclosure.

FIG. 5 illustrates a hardware (entity) schematic of an electronic device according to various embodiments of the present disclosure.

### DETAILED DESCRIPTION

In order to make the objectives, technical solutions and advantages of embodiments of the present disclosure clear, the technical solutions in embodiments of the present disclosure are clearly and completely described below in conjunction with the drawings in embodiments of the present disclosure. Obviously, described embodiments are a part of embodiments of the present disclosure, but not all embodiments. The following embodiments are configured to illustrate the present disclosure but are not intended to limit the scope of the present disclosure. Based on embodiments in the present disclosure, all other embodiments obtained by those skilled in the art without creative efforts fall within the scope of protection of the present disclosure.

In the following description, references are made to “some embodiments” which describe a subset of all possible embodiments. However, it may be understood that “some embodiments” may be a same subset or different subsets of all possible embodiments and may be combined with each other without conflict.

It should be noted that the terms “first\second\third” in embodiments of the present disclosure are only configured to distinguish similar objects and do not represent a specific ordering of objects. It may be understood that “first\second\third” may interchange specific orders or sequences where permitted, such that embodiments of the present disclosure described herein may be implemented in other sequences than illustrated or described herein.

It may be understood by those skilled in the art that, unless otherwise defined, all terms (including technical terms and scientific terms) used herein have same meanings as those generally understood by those skilled in the art in embodiments of the present disclosure. It should also be understood that terms, such as those defined in dictionaries, are to be understood to have meanings consistent with the meaning in the context of the existing technology and are not to be used in an idealistic or overly descriptive manner unless specifically defined herein.

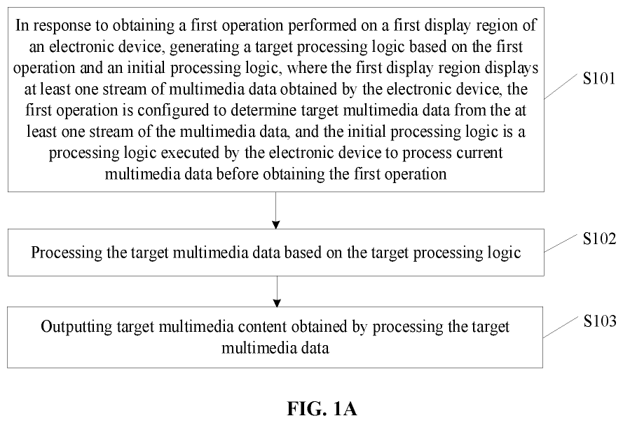

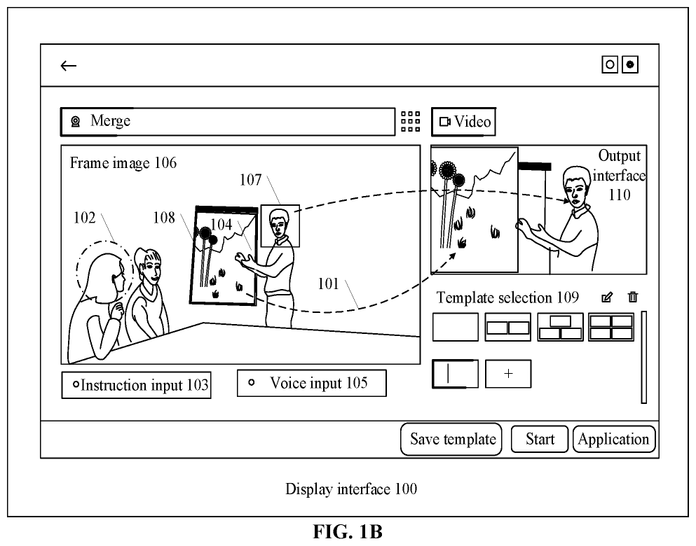

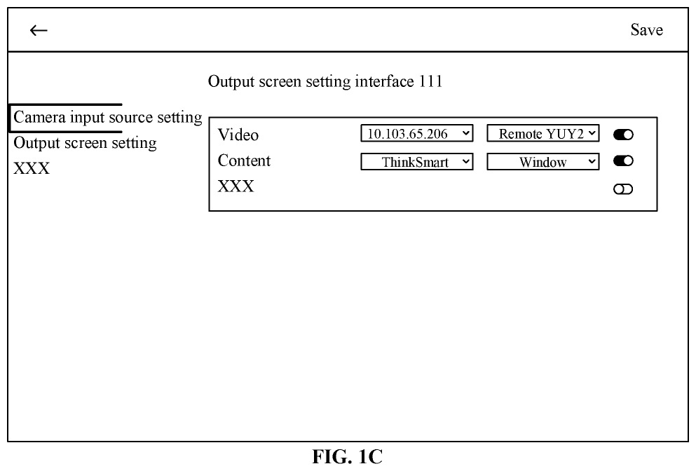

The present disclosure provides a processing method. FIG. 1A illustrates a flowchart of a processing method according to various embodiments of the present disclosure. As shown in FIG. 1A, the method may at least include following exemplary steps.

At S101, in response to obtaining a first operation performed on a first display region of the electronic device, a target processing logic may be generated based on the first operation and an initial processing logic. The first display region may display at least one stream of multimedia data obtained by the electronic device; the first operation may be configured to determine target multimedia data from at least one stream of multimedia data; and the initial processing logic may be a processing logic executed by the electronic device to process current multimedia data before obtaining the first operation.

The electronic device may be a device capable of video processing; may also be a device capable of multimedia data collection, for example, a device for video collection; and may also be a device capable of displaying multimedia data, for example, a device including at least two display regions for displaying multimedia data. Exemplarily, the electronic device may be a desktop computer, a personal computer (PC) including a camera, a tablet computer including a camera, or a smart terminal (e.g., mobile phone) including a camera. Exemplarily, as shown in FIG. 1B, the at least two display regions may be one of the following: a display region of a frame image 106 or other regions in a display interface 100 except the frame image 106. The other regions may be a template selection region 109, or an output interface 110.

The first display region may be a display region of a user interface in target application software. Exemplarily, the first display region may be a preview region in video chat software or video conferencing software, as shown in FIG. 1B, the display region of the frame image 106.

The first operation may include at least one of the following: a drag operation, a circle-selection operation, an instruction input operation, a gesture input operation, and a voice input operation. Exemplarily, as shown in FIG. 1B, the first operation may be a drag operation 101, a circle-selection operation 102, an instruction input operation 103, a gesture input operation 104, and a voice input operation 105.

The initial processing logic may include a target detection operation on multimedia data, exemplarily, include a detection operation on a target object in each frame of the video, a human face detection, a whiteboard detection, or the like. Exemplarily, as shown in FIG. 1B, face detection may be performed on any frame image 106 in the video to obtain detected human face 107; or the whiteboard detection may be performed on any frame image 106 in the video to obtain detected whiteboard 108. The initial processing logic may also include an operation of cropping the target object obtained after target detection. Exemplarily, as shown in FIG. 1B, the human face 107 may be cropped.

The target processing logic may be configured to process at least one stream of multimedia video in the first display region to output target multimedia content. The target multimedia content may be content that multiple target objects in multiple streams of videos are displayed on one output interface; and may also be content that multiple target objects in one stream of multimedia video after editing, such as adjusting position, display size and other display parameters, are displayed on one output interface.

The target multimedia data may include at least one of the following: multimedia data of the target object and multimedia data of target content. The multimedia data of the target object may be a video including portraits, a video including whiteboards, or a video including other elements. The multimedia data of the target content may be the content of a presentation or a document.

In an implementation manner, 101 of generating the target processing logic based on the first operation and the initial processing logic may include following exemplary steps. At 1011A, display position information of the target multimedia data in a second display region of the electronic device may be determined based on the first operation; and at 1012A, the initial processing logic may be processed to obtain the target processing logic based on the display position information and the display parameter of the target multimedia data.

The second display region may be one of other regions in the user interface except the first display region. Exemplarily, as shown in FIG. 1B, other regions may include the template selection region 109, or the video output interface 110. The display parameter may include a display size of the target multimedia data, or a display layout of the target multimedia data.

Exemplarily, when the first operation is the drag operation 101, the target multimedia data is the human face 107, and the display size is the aspect ratio of the display region, after dragging the human face 107 from the first display region to the second display region, the display position information of the human face 107 in the second display region may be determined; the size of the cropping box for cropping the human face 107 may be adjusted based on the aspect ratio of the display region to obtain the size of the cropping box for cropping the human face 107 in the first display region, such that the display position information of the human face 107 in the second display region may be obtained, and the human face 107 may be displayed with the size of the cropping box based on the display position information. In above-mentioned example, the target processing logic may include the display position information and the size of the cropping box (e.g., the display size in the second display region).

In another implementation manner, 101 of generating the target processing logic based on the first operation and the initial processing logic may include following exemplary steps. At 1011B, the display position information of the target multimedia data in the second display region of the electronic device may be determined based on the first operation; at 1012B, the initial processing logic may be processed to obtain the target processing logic based on the display position information and the display output parameter of the target multimedia data. The display output parameter may be obtained based on display configuration information of an output device to which the target multimedia data is to be outputted.

The output device may be a device connected to the electronic device through a target connection manner. Exemplarily, the output device may be a display connected to the electronic device through a network, a transmission line, or a Bluetooth connection. The display configuration information of the output device may include size information of the display interface of the output device, or pixel pitches of pixels in the display interface of the output device. Exemplarily, the display configuration information may be the size information of the display interface or resolution of the display.

Exemplarily, the size information of the display interface of the display may be determined as the display output parameter. The human face 107 in the first display region may be cropped based on the set size of the cropping box; and the cropped human face 107 may be scaled based on the size information of the display interface of the display, such that the display position information of the human face 107 in the second display region and the human face 107 satisfying the size information of the display interface may be obtained. In above-mentioned example, the target processing logic may include the display position information and the display size of the human face (e.g., the human face 107 satisfying the size information of the display interface).

The configuration information of the output device may be address information of the video, a color coding mode of the video, an operating system of the output screen, and the like. Exemplarily, the configuration information of the output device may be configured through the output screen setting interface 111.

In another embodiment, 101 of generating the target processing logic based on the first operation and the initial processing logic may include 1011A, 1012A, 1011B, and 1012B, which may not be described again herein.

At S102, the target multimedia data may be processed based on the target processing logic.

The target processing logic and the initial processing logic may have at least one different processing parameter. Exemplarily, the size information of the display interface of the display in the target processing logic may be different from the size of the cropping box configured in the initial processing logic.

Exemplarily, as shown in FIG. 1B, cropped human face 107 may be processed based on the size information of the display interface of the display.

At S103, the target multimedia content obtained by processing the target multimedia data may be outputted.

In an implementation manner, S103 of outputting the target multimedia content obtained by processing the target multimedia data may include displaying and outputting the target multimedia content to a same display or different display screens based on the type of the multimedia content.

Displaying and outputting of the target multimedia content to a same display screen or different display screens may include performing split-screen display or same-screen display of the target multimedia content. Exemplarily, the electronic device may display images or videos through one display screen.

In another implementation manner, S103 of outputting the target multimedia content obtained by processing the target multimedia data may include outputting the target multimedia content to a target output component of the electronic device. The target output component may be determined based on attribute information of the target multimedia content.

The target output component may at least include a microphone. Exemplarily, when the target multimedia content is audio, the audio may be outputted to the microphone of the electronic device.

In another implementation manner, S103 of outputting the target multimedia content obtained by processing the target multimedia data may include outputting the target multimedia content to a target application.

The target application may be a multimedia application, for example, video chat software. Exemplarily, when the target multimedia content is video, the video may be outputted to the video chat software. In other embodiments, there may be multiple target applications. That is, the target multimedia content may be outputted to multiple different applications simultaneously, such that multiple users may access the target multimedia content through different applications.

In another implementation manner, S103 of outputting the target multimedia content obtained by processing the target multimedia data may include outputting the target multimedia content to an output device having a target connection with the electronic device.

Exemplarily, when the target multimedia content is video, the video may be transmitted to another device through network connection and outputted from another device.

In another implementation manner, S103 of outputting the target multimedia content obtained by processing the target multimedia data may include one of above-mentioned implementation manners or a combination thereof, which may not be described in detail herein.

In embodiments of the present disclosure, in response to obtaining the first operation performed on the first display region of the electronic device, the target processing logic may be generated based on the first operation and the initial processing logic. The first display region may display at least one stream of multimedia data obtained by the electronic device, the first operation may be configured to determine the target multimedia data from at least one stream of multimedia data, and the initial processing logic may be a processing logic executed by the electronic device to process current multimedia data before obtaining the first operation. In such way, the target multimedia data may be determined from at least one stream of multimedia data in the first display region. The target multimedia data may be processed based on the target processing logic; and the target multimedia content obtained by processing the target multimedia data may be outputted. In such way, it realizes that the target processing logic may be configured to process the target multimedia data originating from at least one stream of multimedia data, and the multimedia data satisfying the target processing logic may be obtained, which may avoid using different algorithms to process the multimedia data in each interactive interface in multiple interactive interfaces and reduce screen fusion complexity of the multimedia data, thereby reducing the user's learning cost during using process, simplifying user operation, and improving user experience.

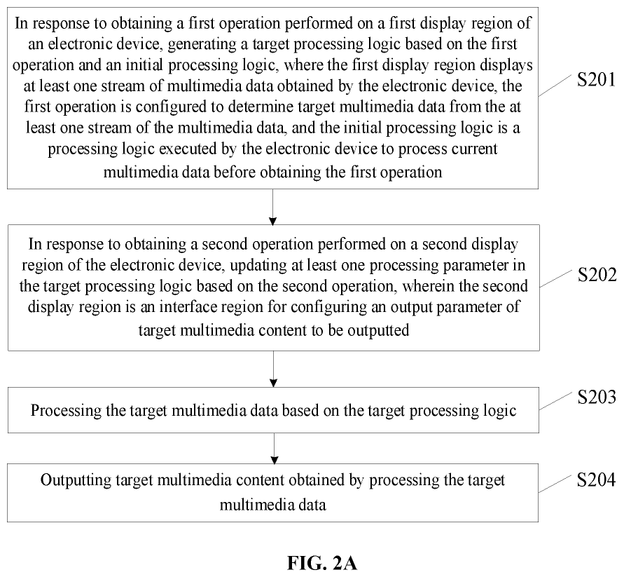

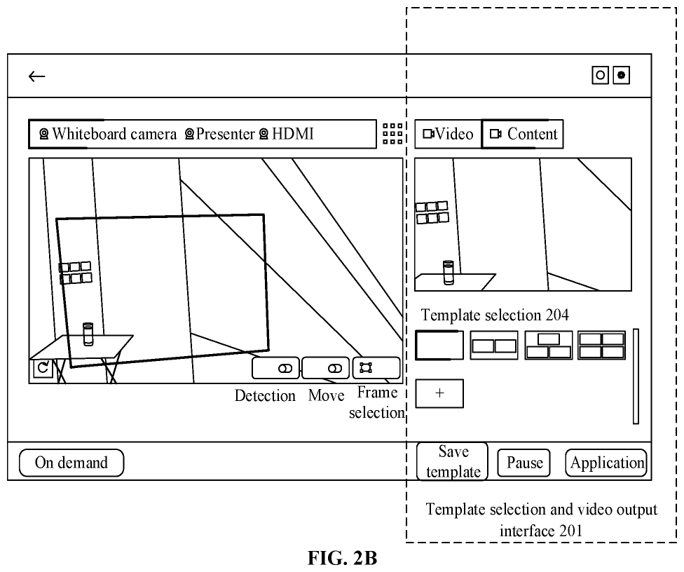

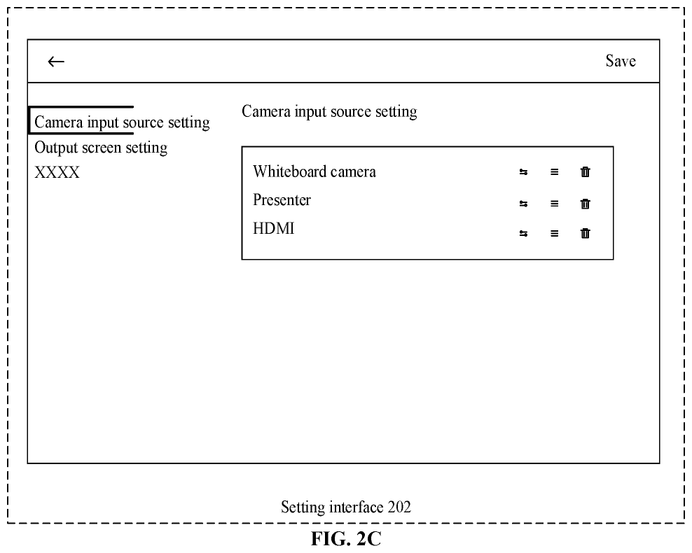

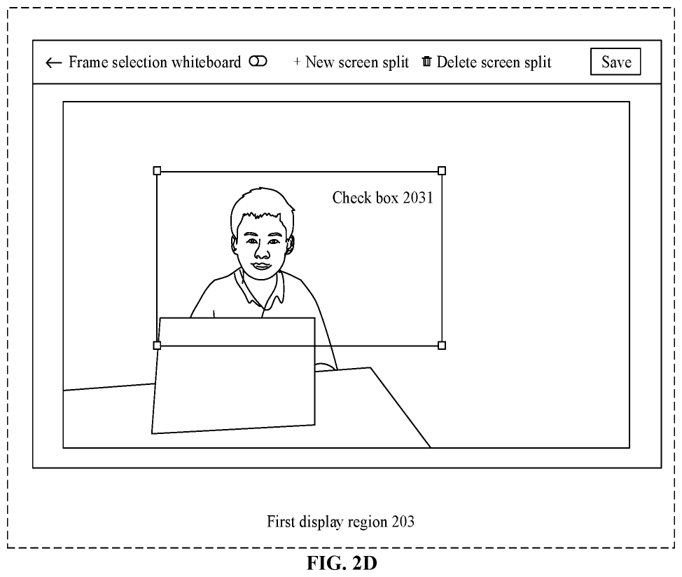

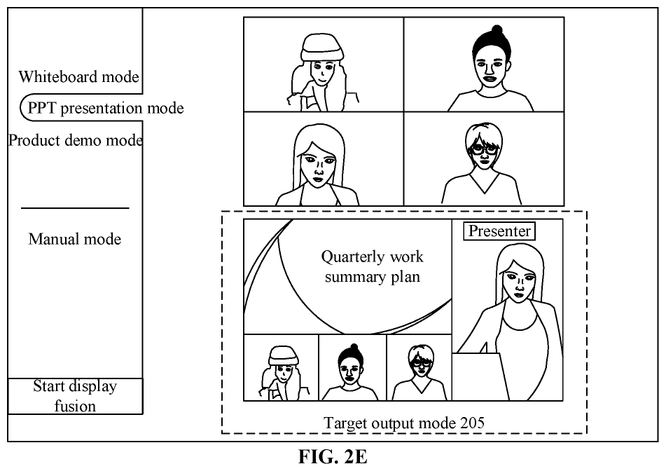

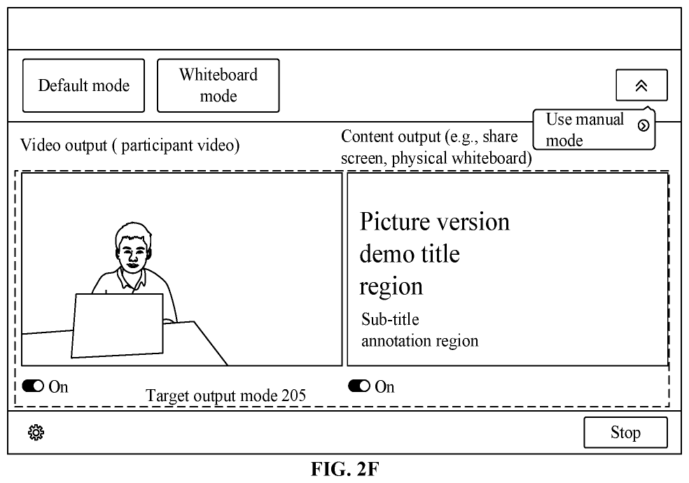

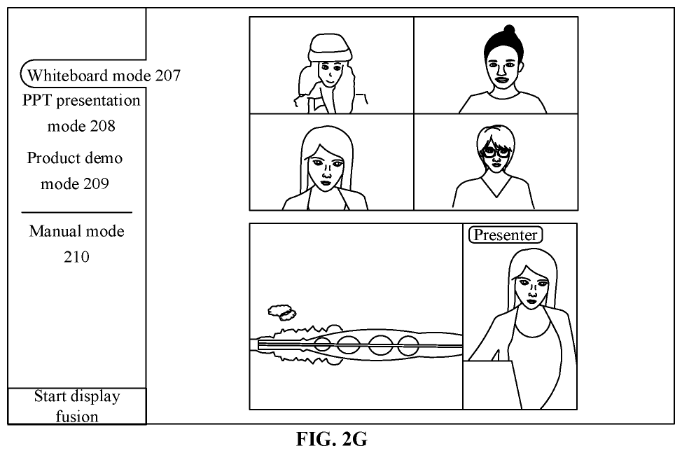

The present disclosure provides a processing method. FIG. 2A illustrates another flowchart of a processing method according to various embodiments of the present disclosure. As shown in FIG. 2A, the method may at least include following exemplary steps.

At S201, in response to obtaining the first operation performed on the first display region of the electronic device, the target processing logic may be generated based on the first operation and the initial processing logic. The first display region may display at least one stream of multimedia data obtained by the electronic device; the first operation may be configured to determine the target multimedia data from at least one stream of multimedia data; and the initial processing logic may be a processing logic executed by the electronic device to process current multimedia data before obtaining the first operation.

At S202, in response to obtaining a second operation performed on the second display region of the electronic device, at least one processing parameter in the target processing logic may be updated based on the second operation. The second display region may be an interface region used to configure the output parameter of the target multimedia content to be outputted.

Exemplarily, the second display region may be a template selection and video output interface 201 as shown in FIG. 2B; and may also be a setting interface 202 as shown in FIG. 2C. As shown in FIG. 2B, the first display region and the second display region may be displayed on a same display screen. As shown in FIGS. 2C and 2D, the second display region (the setting interface 202) and the first display region 203 may be displayed on a display screen respectively.

In an implementation manner, S202 of updating at least one processing parameter in the target processing logic based on the second operation may include at least one of the following: determining the configuration option of the second operation and updating corresponding processing parameter in the target processing logic based on the configuration parameter corresponding to the configuration option.

The configuration options may be configuration options displayed in a configuration region, such as an output type, an output layout, and the like. The configuration options herein may include configuration options on a first screen and may also include configuration options on other setting interfaces. Exemplarily, the configuration option may be any output layout in template selection 204 as shown in FIG. 2B and may also be any configuration option in the setting interface as shown in FIG. 2C, for example, camera input source setting.

The operation information of the second operation may be determined, and corresponding configuration parameter may be generated based on the operation information, thereby updating corresponding processing parameter in the target processing logic based on the configuration parameter.

The operation information may include at least one of the following: an operation position, an operation object, an operation track, an operation input, and the like. The configuration parameter may be generated, based on the operation information, to configure the target processing logic.

Exemplarily, as shown in FIG. 1B, the operation information may include the coordinate information of the human face 107, the whiteboard 108 of the operation object, the circle of the operation trajectory of the circle-selection operation 102, and the operation input of the instruction input operation 103 and the voice input operation 105.

In above-mentioned embodiments, the configuration option of the second operation may be determined, and corresponding processing parameter in the target processing logic may be updated based on the configuration parameter corresponding to the configuration option; and the operation information of the second operation may be determined, corresponding configuration parameter may be generated based on the operation information, thereby updating corresponding processing parameter in the target processing logic based on the configuration parameter. In such way, the processing parameters corresponding to the target processing logic may be adjusted by adjusting the configuration option and operation information of the second operation, which may achieve flexible update to the target processing logic, quickly and efficiently satisfy various processing needs of users for the target multimedia data and improve user experience.

In an implementation manner, the method may further include the following: switching the multimedia data currently displayed in the first display region based on the first operation, thereby determining multiple streams of target multimedia data from multiple streams of the multimedia data.

Switching may include switching data sources and switching display parameters such as display layouts, display sizes, and the like. Exemplarily, as shown in FIG. 2C, the data source may be switched through camera input source setting. As shown in FIG. 1B, the display layout may be the relative position of the human face and the whiteboard in the output interface 110. The display size may be the size of the region occupied by the whiteboard in the output interface 110.

A target output mode may be determined based on the type of the target multimedia content, thereby correspondingly outputting the target multimedia content based on the target output mode.

Exemplarily, as shown in FIG. 2E, in the case where the type of the target multimedia content includes the type of multiple human faces and presentation (PPT), the target multimedia content, outputted according to the target output mode 205 that the maximum region is placed in the output mode and a plurality of human faces are placed around the PPT, may be determined.

Exemplarily, as shown in FIG. 2F, in the case where the type of the target multimedia content includes the type of one participant and presentation (PPT), the target multimedia content, which is outputted according to the target output mode 205 that the PPT and participant are displayed side by side, may be determined.

The output mode of the target multimedia content may be determined based on the third operation on the electronic device, such that the target multimedia content may be outputted separately or synchronously according to corresponding type based on determined output mode.

The third operation may be an operation of selecting the output mode. As shown in FIG. 1B, the third operation may be determining the target output mode from five output modes included in the template selection 109.

At S203, the target multimedia data may be processed based on the target processing logic.

At S204, the target multimedia content obtained by processing the target multimedia data may be outputted.

In an implementation manner, the method may further include determining an application scenario mode of the target multimedia content based on a fourth operation performed on the electronic device.

Exemplarily, as shown in FIG. 2G, the application scenario mode may include one of the following: a whiteboard mode 207, a PPT presentation mode 208, a product demonstration (demo) mode 209, and a manual mode 210.

In an implementation manner, the position information of each object in the target multimedia data may be stored in each output mode. In the process of switching the output modes of the target multimedia data, multiple output modes of the target multimedia data may be quickly switched based on stored location information.

In above-mentioned embodiments, the multimedia data currently displayed in the first display region may be switched based on the first operation, such that multiple streams of the target multimedia data may be determined from the multiple streams of the multimedia data. In such way, determined target multimedia data may include target objects in multiple streams of the multimedia data. The target output mode may be determined based on the type of the target multimedia content, such that the target multimedia content may be correspondingly outputted based on the target output mode. In such way, flexible layout of the target multimedia content may be achieved, such that the outputted target multimedia content may be more consistent with user needs, which may avoid manually adjusting the output mode of the target multimedia content by the user, simplify user operation, and improve user experience. The output mode of the target multimedia content may be determined based on the third operation on the electronic device, and the target multimedia content may be outputted separately or synchronously according to corresponding type based on determined output mode. In such way, same type of the target multimedia content may be outputted synchronously to simplify the user's operation on same type of the target multimedia content, or different types of the target multimedia content may be outputted separately to facilitate user viewing.

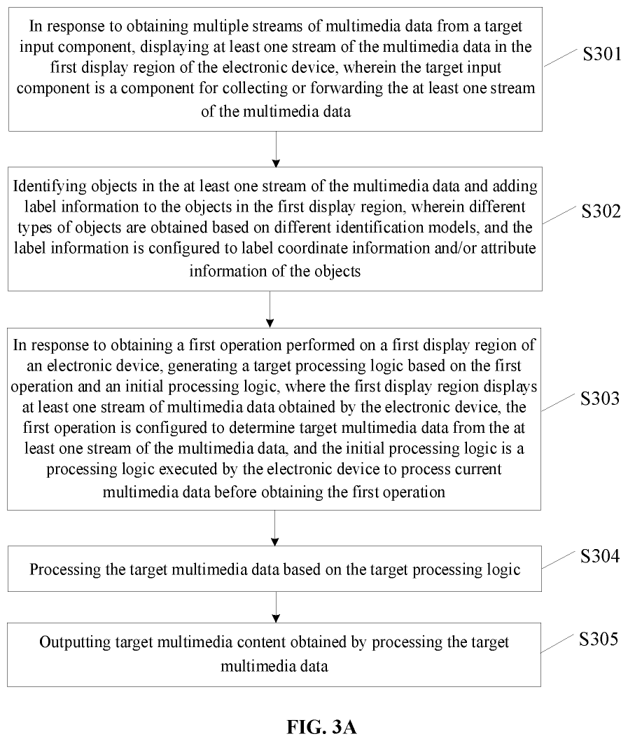

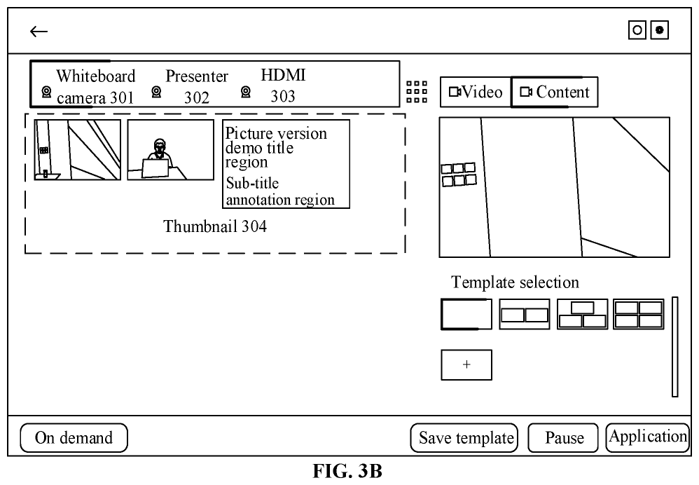

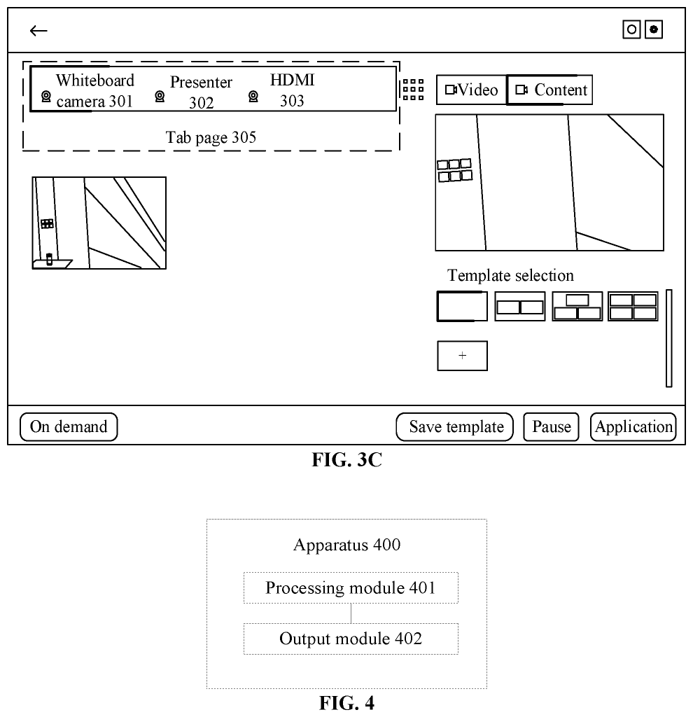

The present disclosure provides a processing method. FIG. 3A illustrates another flowchart of a processing method according to various embodiments of the present disclosure. As shown in FIG. 3A, the method may at least include following exemplary steps.

At S301, in response to obtaining multiple streams of the multimedia data from a target input component, at least one stream of the multimedia data may be disposed in the first display region of the electronic device, where the target input component may be a component that collects or forwards the multimedia data.

The target input component may include one of the following: a camera, a microphone, or a multimedia application. Exemplarily, as shown in FIG. 3B, the target input component may include a whiteboard camera 301 for photographing the whiteboard, a camera 302 for photographing the speaker, and a PPT (multimedia application) transmitted through a High Definition Multimedia Interface (HDMI) 303.

In an implementation manner, at least one stream of the multimedia data in the first display region may be displayed in the form of thumbnail 304 as shown in FIG. 3B. In another implementation manner, as shown in FIG. 3C, at least one stream of the multimedia data in the first display region may be displayed in the form of a tab page 305. When the tab of the whiteboard camera 301 is selected, corresponding multimedia data may be displayed.

At S302, objects in the multimedia data may be identified, and label information may be added to the objects in the first display region. Different types of objects may be obtained based on different identification models, and the label information may be configured to label the coordinate information and/or attribute information of the objects.

Exemplarily, as shown in FIG. 1B, content identification and preview may be performed on original video frame (e.g., the frame image 106). As shown in the region where the frame image 106 is located, 108 is used to label identified whiteboard, and 107 is used to label identified human face.

Multiple identification algorithms may be applied to the original video frame (e.g., the frame image 106) simultaneously. Objects identified by different algorithms may be labeled using [coordinate system, element category]. Different types of objects may have different coordinate systems. For example, the number of coordinate points included in the coordinate system may be different. The whiteboard may contain four vertex coordinates, and the human face may only require the coordinates of two points in the upper left corner and lower right corner.

Exemplarily, the label information may be attribute information configured to label human face, including personal information such as name, expression, and the like; and may also be color information of the object. In one application scenario that can be implemented, the human face may be added to optimal position in the display layout based on personal information. In another application scenario that can be implemented, expression information of exciting and joyful human face in online event meeting may be extracted and displayed based on expression information.

At S303, in response to obtaining the first operation performed on the first display region of the electronic device, the target processing logic may be generated based on the first operation and the initial processing logic. The first display region may display at least one stream of multimedia data obtained by the electronic device; the first operation may be configured to determine the target multimedia data from at least one stream of multimedia data; and the initial processing logic may be a processing logic executed by the electronic device to process current multimedia data before obtaining the first operation.

At S304, the target multimedia data may be processed based on the target processing logic.

At S305, the target multimedia content obtained by processing the target multimedia data may be outputted.

In above-mentioned embodiments, in response to obtaining multiple streams of the multimedia data from the target input component, at least one stream of the multimedia data may be displayed in the first display region of the electronic device. The target input component may be a component that collects or forwards the multimedia data. In such way, different types of multiple streams of the multimedia data may be obtained through multiple input components. Objects in the multimedia data may be identified, and label information may be added to the objects in the first display region. Different types of objects may be obtained based on different identification models, and the label information may be configured to label the coordinate information and/or attribute information of the objects. In such way, the display effect of the object may be adjusted through the label information.

In an implementation manner, the method may further include S306 of determining the target multimedia data from at least one stream of the multimedia data displayed in the first display region based on the first operation.

Correspondingly, S306 of determining the target multimedia data from at least one stream of the multimedia data displayed in the first display region based on the first operation may include at least one of following exemplary steps.

At S3061, the target object may be determined from the multimedia data based on the first operation, and the multimedia data containing the target object may be determined as the target multimedia data.

The multimedia data containing the target object may be the multimedia data that the size of the target object does not change, that is, the multimedia data that is not cropped. Exemplarily, entire whiteboard 108 in FIG. 1B may be outputted without cropping.

At S3062, the target object may be determined from the multimedia data based on the first operation, and corresponding multimedia data may be cropped with corresponding first cropping parameter based on the label information of the target object to obtain the target multimedia data.

The first cropping parameter may be an initial cropping parameter, that is, the size information of the cropping box set for the target object without considering the output layout. Exemplarily, as shown in FIG. 1B, the whiteboard 108 may be cropped according to set size information of the cropping box, and the portion of the output layout that is not filled with the whiteboard 108 may be filled with a black border.

At S3063, the target object from the multimedia data may be determined based on the first operation, and corresponding multimedia data may be cropped with corresponding second cropping parameter based on the label information and output layout information of the target object to obtain the target multimedia data.

Exemplarily, as shown in FIG. 1B, based on the position information of the center position of the human face, the human face may be cropped in the original video (e.g., the frame image 106) according to the aspect ratio of the target region in the display layout.

At S3064, based on that the first operation is the circle-selection operation of circling the target object from the multimedia data, the multimedia data selected by the circle-selection operation may be determined as the target multimedia data.

Exemplarily, as shown in FIG. 1B, the circle-selection operation 102 may select a target face from the frame image 106.

In above-mentioned embodiments, the target object may be determined from the multimedia data based on the first operation, and multimedia data containing the target object may be determined as the target multimedia data. In such way, the target object that cannot be cropped may be determined as the target multimedia data, such that the target multimedia data may include more information about the target object, and richness and completeness of the target object information may be improved. Based on the first operation, the target object may be determined from the multimedia data, and corresponding multimedia data may be cropped with corresponding first cropping parameter based on the label information of the target object to obtain the target multimedia data. In such way, the target object may be cropped through the label information, which may improve effectiveness of the target object information in the target multimedia data. The target object may be determined from the multimedia data based on the first operation, and corresponding multimedia data may be cropped with corresponding second cropping parameter based on the label information and output layout information of the target object to obtain the target multimedia data. In such way, the target object may be cropped while considering the output layout, which may improve the output effect of the output target multimedia data and enhance the user experience.

In an implementation manner, S3061 to S3063 of determining the target object from the multimedia data based on the first operation may include one of following steps.

In response to the first operation is a drag operation of dragging the first object labeled in the first display region from a first position to a second position, the first object may be determined to be the target object, where the second position may be located outside the first display region.

Exemplarily, as shown in FIG. 1B, the drag operation 101 may drag the whiteboard 108 (e.g., the first object/target object) from the first position in the first display region to the second position in the second display region.

Exemplarily, when the second display region is another display interface different from the first display region, the drag operation 101 may drag the whiteboard 108 from the display interface of the first display region to the display interface of the second display region for displaying; and in the display interface, the whiteboard may be displayed at the second position.

In response to the first operation is a circle-selection operation that is performed on the first display region, the object circled by the circle-selection operation may be determined as the target object.

Exemplarily, as shown in FIG. 1B, the circle-selection operation 102 may determine the human face as the target object. Exemplarily, as shown in FIG. 2D, the circle-selection operation may be a check box 2031, and the human face may be determined to be the target object through the check box 2031.

In an implementation manner, the position range of the target object may be determined through a circle-selection operation, which may avoid the problem of being unable to select the target object when the target object is not in the center of the camera shooting range.

In response to the first operation is an instruction input operation that is performed on the electronic device or the first display region, the object or region content that matches the instruction inputted by the instruction input operation may be determined as the target object.

Exemplarily, as shown in FIG. 1B, the operation of the instruction input 103 may be text. For example, the instruction input operation may, through the target path, loading a multimedia application (PPT) under the target path.

Exemplarily, as shown in FIG. 1B, the target object may also be determined through a voice input 105, for example, “let's take a look at the content on the whiteboard together” and the like.

In response to the first operation is a gesture input operation that is performed on the electronic device or the first display region, the object or region content that matches the gesture inputted by the gesture input operation may be determined as the target object.

Exemplarily, as shown in FIG. 1B, through the gesture input operation 104, the user may be guided to look at the content on the whiteboard, and the whiteboard pointed by the gesture (the object matched by the gesture) or the content of the whiteboard region (the content of the region matched by the gesture) may be determined as the target object.

In above-mentioned embodiments, the target object may be determined from the multimedia data through multiple operation manners such as drag operation, circle-selection operation, instruction input operation, and gesture input operation, which may facilitate the user operation and improve the user experience.

In above-mentioned embodiments, for the target object in the target multimedia data in the first display region, the coordinates of the target object may be determined in real time, and the video of the target object may be displayed in the second display region.

Taking the multimedia data being video as an example to illustrate a processing method provided by the present disclosure, in the application scenario of performing screen fusion on videos, different algorithms may need to be applied to different types of video content, and the interaction logic may be complex and cumbersome. In the existing technology, the problem of applying multiple algorithms to process different types of videos may be solved by using different interactive interfaces to operate different types of video content. However, in the application scenario where multiple interactive interfaces are operated, there may be problems such as unnatural interface interaction, high learning cost during user's usage, and inability to use the interfaces quickly.

In order to solve above-mentioned problems, the present disclosure provides a processing method. The method may include analyzing and previewing the video and adding different label information to different types of content (e.g., different types of objects) in the preview screen (e.g., the first display region), for example, labeling the content as the human face, the whiteboard or document; and placing different types of content in the preview screen at the target location (e.g., the second position) through the drag operation and applying corresponding algorithms (e.g., different identification models) according to types. Exemplarily, a tracking algorithm may be applied for the human face; and algorithms including keystone correction, foreground erasure, graphics enhancement and the like may be applied for the whiteboard. In addition, by placing the whiteboard and human face to the fusion screen interface (e.g., second display region) on the right through the drag operation, the whiteboard part may automatically apply algorithms such as keystone correction and image enhancement to provide a desirable whiteboard effect. The human face part may apply automatic tracking function. Exemplarily, the target object to be dragged and corresponding coordinate system may be determined according to the trigger point of the drag action; and corresponding algorithm may be applied according to the type of the target object. In an implementation manner, commonly used screen fusion scenarios (e.g., the output mode) may be saved as scenario templates, and the screen fusion information (e.g., the position information of the target object in the output mode) and screen fusion manner may be recorded. Exemplarily, for “whiteboard mode” and “PPT presentation mode”, the screen fusion information of corresponding mode may be loaded through a click operation to achieve rapid switching between different modes.

In above-mentioned embodiment, different types of content in the preview screen may be placed to the target location through the drag operation, flexible layout of the video screen fusion and automatic matching application of the algorithm may be realized on a same interface, which may achieve fast and efficient effect.

Based on above-mentioned embodiments, embodiments of the present disclosure further provide a processing apparatus. The control device may include each included module, which may be implemented by a processor in the electronic device, and obviously may also be implemented by a specific logic circuit. During the implementation process, the processor may be a central processing unit (CPU), a micro processing unit (MPU), a digital signal processor (DSP), a field programmable gate array (FPGA), and/or the like.

FIG. 4 illustrates a structural schematic of a processing apparatus according to various embodiments of the present disclosure. As shown in FIG. 4, a apparatus 400 may include a processing module 401 and an output module 402.

The processing module 401 may be configured to, in response to obtaining the first operation performed on the first display region of the electronic device, generate the target processing logic based on the first operation and the initial processing logic. The first display region may display at least one stream of multimedia data obtained by the electronic device, the first operation may be configured to determine the target multimedia data from at least one stream of multimedia data, and the initial processing logic may be the processing logic executed by the electronic device to process current multimedia data before obtaining the first operation. The processing module 401 may be further configured to process the target multimedia data based on the target processing logic.

The output module 402 may be configured to output the target multimedia content obtained by processing the target multimedia data.

In an implementation manner, the apparatus 400 may further include an update module.

The update module may be configured to update at least one processing parameter in the target processing logic based on the second operation in response to obtaining the second operation performed on the second display region of the electronic device. The second display region may be an interface region used to configure the output parameter of the target multimedia content to be outputted.

In an implementation manner, the update module may be further configured for at least one of the following: determining the configuration option of the second operation and updating corresponding processing parameter in the target processing logic based on the configuration parameter corresponding to the configuration option; and determining the operation information of the second operation and generating corresponding configuration parameter based on the operation information, thereby updating corresponding processing parameter in the target processing logic based on the configuration parameter.

In an implementation manner, the apparatus 400 may further include a display module and an identification module. The display module may be configured to, in response to obtaining multiple streams of the multimedia data from the target input component, display at least one stream of the multimedia data in the first display region of the electronic device, where the target input component may be a component that collects or forwards the multimedia data. The identification module may be configured to identify objects in the multimedia data and add label information to the objects in the first display region. Different types of objects may be obtained based on different identification models, and the label information may be configured to label the coordinate information and/or attribute information of the objects.

In an implementation manner, the apparatus 400 may further include a first determining module. The first determination module may be configured to determine the target multimedia data from at least one stream of multimedia data displayed in the first display region based on the first operation. Correspondingly, the first determination module may be further configured for at least one of the following: determining the target object from the multimedia data based on the first operation, and determining the multimedia data containing the target object as the target multimedia data; determining the target object from the multimedia data based on the first operation, and cropping corresponding multimedia data with corresponding first cropping parameter based on the label information of the target object to obtain the target multimedia data; determining the target object from the multimedia data based on the first operation, and cropping corresponding multimedia data with corresponding second cropping parameter based on the label information and output layout information of the target object to obtain the target multimedia data; and based on that the first operation is the circle-selection operation of circling the target object from the multimedia data, determining the multimedia data selected by the circle-selection operation as the target multimedia data.

In an implementation manner, the first determination module may be further configured for one of the following: in response to the first operation is the drag operation of dragging the first object labeled in the first display region from the first position to the second position, determining the first object to be the target object, where the second position may be located outside the first display region; in response to the first operation is the circle-selection operation that is performed on the first display region, determining the object circled by the circle-selection operation as the target object; in response to the first operation is the instruction input operation that is performed on the electronic device or the first display region, determining the object or region content that matches the instruction inputted by the instruction input operation as the target object; and in response to the first operation is the gesture input operation that is performed on the electronic device or the first display region, determining the object or region content that matches the gesture inputted by the gesture input operation as the target object.

In an implementation manner, the processing module 401 may be further configured for at least one of the following: determining display position information of the target multimedia data in the second display region of the electronic device based on the first operation and processing the initial processing logic to obtain the target processing logic based on the display position information and the display parameter of the target multimedia data; and determining display position information of the target multimedia data in the second display region of the electronic device based on the first operation and processing the initial processing logic to obtain the target processing logic based on the display position information and the display output parameter of the target multimedia data. The display output parameter may be obtained based on display configuration information of an output device to which the target multimedia data is to be outputted.

In an implementation manner, the apparatus 400 may further include at least one of the following: a switching module, configured to switch the multimedia data currently displayed in the first display region based on the first operation, thereby determining multiple streams of target multimedia data from the multiple streams of the multimedia data; a second determination module, configured to determine the target output mode based on the type of the target multimedia content, thereby correspondingly outputting the target multimedia content based on the target output mode; and a third determination module, configured to determine the output mode of the target multimedia content based on the third operation on the electronic device, such that the target multimedia content may be outputted separately or synchronously according to corresponding type based on determined output mode.

In an implementation manner, the output module 402 may be configured for at least one of the following: displaying and outputting the target multimedia content to a same display screen or different display screens based on the type of the multimedia content; outputting the target multimedia content to the target output component of the electronic device, where the target output component may be determined based on attribute information of the target multimedia content; and outputting the target multimedia content to the target application; and outputting the target multimedia content to the output device having a target connection with the electronic device.

It should be noted herein that the description of above apparatus embodiments may be similar to the description of above method embodiments and have similar beneficial effects as the method embodiments. Technical details not disclosed in the apparatus embodiments of the present disclosure may refer to the description of the method embodiments of the present disclosure.

It should be noted that in embodiments of the present disclosure, in response to above method is implemented in the form of a software function module which is sold or used as an independent product, the software function module may also be stored in a computer-readable storage medium. Based on such understanding, the essential or contribution part of the technical solutions of embodiments of the present disclosure may be embodied in the form of software products. The computer software product may be stored in a storage medium and include multiple instructions to cause the electronic device to execute all or part of the methods described in various embodiments of the present disclosure. The above-mentioned storage media may include U disks, mobile hard disks, read only memory (ROM), magnetic disks, optical disks and/or other media that may store program codes. Therefore, embodiments of the present disclosure may not be limited to any specific combination of hardware and software.

Correspondingly, embodiments of the present disclosure provide a computer-readable storage medium that a computer program may be stored. When the computer program is executed by a processor, the steps in any one of the methods described in above-mentioned embodiments may be implemented.

Correspondingly, embodiments of the present disclosure further provide a chip. The chip may include programmable logic circuits and/or program instructions. When the chip is running, the chip may be configured to implement the steps in any one of the methods in above-mentioned embodiments.

Correspondingly, embodiments of the present disclosure further provide a computer program product. When executed by a processor of the electronic device, the computer program product may be configured to implement the steps in any one of the methods described in above-mentioned embodiments.

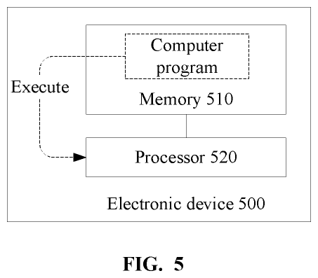

Based on same technical concept, embodiments of the present disclosure provide an electronic device for implementing the processing method described in above method embodiments. FIG. 5 illustrates a hardware (entity) schematic of an electronic device according to various embodiments of the present disclosure. As shown in FIG. 5, an electronic device 500 may include a memory 510 and a processor 520. The memory 510 may store a computer program capable of being executed on the processor 520. When the processor 520 executes the program, the steps in any one of the methods described in embodiments of the present disclosure may be implemented.

The memory 510 may be configured to store instructions and applications executable by the processor 520 and may also cache data to-be-processed or data processed by the processor 520 and various modules in the electronic device (e.g., image data, audio data, voice communication data, and video communication data), which may be implemented through flash memory (FLASH) or random access memory (RAM).

When the processor 520 executes the program, the steps of any one of above processing methods may be implemented. The processor 520 may control overall operation of the electronic device 500.

Above-mentioned processor may be an application specific integrated circuit (ASIC), a digital signal processor (DSP), a digital signal processing device (DSPD), a programmable logic device (PLD), a field programmable gate array (FPGA), a central processing unit (CPU), a controller, a microcontroller, and/or a microprocessor. It may be understood that the electronic device that implements above-mentioned processor function may also be another device, which may not be limited in embodiments of the present disclosure.

Above-mentioned computer storage media/memory may be read-only memory (ROM), programmable read-only memory (PROM), erasable programmable read-only memory (EPROM), electrically erasable programmable read-only memory (EEPROM), ferromagnetic random access memory (FRAM), flash memory, magnetic surface memory, compact disc read-only memory (CD-ROM), and/or the like; and may also be various electronic devices including one or any combination of above memories, such as mobile phones, computers, tablet devices, personal digital assistants, and/or the like.

It should be noted herein that above description of the storage medium embodiments and apparatus embodiments may be similar to the description of above method embodiments and may have similar beneficial effects as above method embodiments. Technical details which are not disclosed in the storage medium embodiments and method embodiments of the present disclosure may refer to the description of above method embodiments of the present disclosure.

It should be understood that “one embodiment” or “an embodiment” in the present disclosure may mean that a particular feature, a structure, or a characteristic associated with the embodiment may be included in at least one embodiment of the present disclosure. Therefore, “in one embodiment” or “in an embodiment” in various parts of the present disclosure may not be necessarily referred to same embodiment. Furthermore, particular features, structures or characteristics may be combined in any suitable manner in one or more embodiments. It should be understood that in various embodiments of the present disclosure, the order of the sequence numbers of above-mentioned processes may not mean the sequence of execution. The execution sequence of each process should be determined by its functions and internal logic and should not limit the implementation processes of embodiments of the present disclosure. Above sequence numbers of embodiments of the present disclosure may be only for description and may not indicate advantages or disadvantages of embodiments.

It should be noted that in the present disclosure, the terms “include”, “comprise” or any other variation thereof may be intended to cover a non-exclusive inclusion. Therefore, a process, a method, an article or an apparatus that includes a list of elements may include not only those elements, but also include other elements not expressly listed or elements which are inherent to the process, the method, the article or the apparatus. Without further limitation, an element defined by the statement “comprises a . . . ” may not exclude the presence of additional identical elements in a process, a method, an article or an apparatus that includes such element.

In some embodiments provided in the present disclosure, it should be understood that disclosed apparatuses and methods may be implemented in other manners. The apparatus embodiments described above may be merely illustrative. Exemplarily, the division of units may be only a logical function division, and there may be other division manners in actual implementation. Exemplarily, multiple units or parts may be combined or integrated into another system, or some features may be ignored or not implemented. In addition, the coupling, direct coupling, or communication connection between the parts shown or discussed may be indirect coupling or communication connection through certain interfaces, devices or units, and may be electrical, mechanical or other forms.

The units described above as separate parts may or may not be physically separated; the parts shown as units may or may not be physical units, which may be located in one place or distributed to multiple network units; and some or all of the units may be selected according to actual needs to achieve the purpose of the solutions of embodiments.

In addition, each functional unit in each embodiment of the present disclosure may be all integrated into one processing unit; or each unit may be separately used as one unit; or two or more units may be integrated into one unit. Above integrated unit may be implemented in the form of hardware or in the form of hardware plus software functional units.

Optionally, in response to that the integrated units mentioned above in the present disclosure are implemented in the form of software function modules and sold or used as independent products, the integrated units may also be stored in a computer-readable storage medium. Based on such understanding, the essential part or the contribution part of the technical solutions of embodiments of the present disclosure may be embodied in the form of software products. The computer software product may be stored in a storage medium and include a number of instructions to cause the computer device (which may be a mobile phone, a tablet computer, a desktop computer, a personal digital assistant, a navigator, a digital phone, a video phone, a television, a sensing device or the like) to perform all or part of the methods described in various embodiments of the present disclosure. Above-mentioned storage media may include mobile storage devices, ROMs, magnetic disks or optical disks, and other media that may store program codes.

The methods disclosed in some method embodiments provided in the present disclosure may be combined arbitrarily to obtain new method embodiments without conflict. The features disclosed in some product embodiments provided in the present disclosure may be combined arbitrarily without conflict to obtain new product embodiments.

The features disclosed in some method embodiments or apparatus embodiments provided in the present disclosure may be combined arbitrarily without conflict to obtain new method embodiments or apparatus embodiments.

Compared with the existing technology, the technical solutions provided by the present disclosure may achieve at least the following beneficial effects.

In embodiments of the present disclosure, in response to obtaining the first operation performed on the first display region of the electronic device, the target processing logic may be generated based on the first operation and the initial processing logic. The first display region may display at least one stream of multimedia data obtained by the electronic device, the first operation may be configured to determine the target multimedia data from at least one stream of multimedia data, and the initial processing logic may be a processing logic executed by the electronic device to process current multimedia data before obtaining the first operation. In such way, the target multimedia data may be determined from at least one stream of multimedia data in the first display region. The target multimedia data may be processed based on the target processing logic; and the target multimedia content obtained by processing the target multimedia data may be outputted. In such way, it realizes that the target processing logic may be configured to process the target multimedia data originating from at least one stream of multimedia data, and the multimedia data satisfying the target processing logic may be obtained, which may avoid using different algorithms to process the multimedia data in each interactive interface in multiple interactive interfaces and reduce screen fusion complexity of the multimedia data, thereby reducing the user's learning cost during using process, simplifying user operation, and improving user experience.

The above may merely be embodiments of the present disclosure, but the protection scope of the present disclosure may not be limited thereto. Those skilled in the art may easily think of changes or substitutions within the technical scope disclosed in the present disclosure, which should be covered by the protection scope of the present disclosure. Therefore, the protection scope of the present disclosure should be subject to the protection scope of the claims.

What is claimed is:

1. A processing method, comprising:
in response to obtaining a first operation performed on a first display region of an electronic device, generating a target processing logic based on the first operation and an initial processing logic, wherein the first display region displays at least one stream of multimedia data obtained by the electronic device, the first operation is configured to determine target multimedia data from the at least one stream of the multimedia data, and the initial processing logic is a processing logic executed by the electronic device to process current multimedia data before obtaining the first operation;
processing the target multimedia data based on the target processing logic; and
outputting target multimedia content obtained by processing the target multimedia data.

2. The method according to claim 1, further including:
in response to obtaining a second operation performed on a second display region of the electronic device, updating at least one processing parameter in the target processing logic based on the second operation, wherein the second display region is an interface region for configuring an output parameter of target multimedia content for output.

3. The method according to claim 2, wherein updating the at least one processing parameter in the target processing logic based on the second operation includes one of:
determining a configuration option of the second operation, and updating a corresponding processing parameter in the target processing logic based on a configuration parameter corresponding to the configuration option; and
determining operation information of the second operation, generating a corresponding configuration parameter based on the operation information, and updating a corresponding processing parameter in the target processing logic based on the corresponding configuration parameter.

4. The method according to claim 1, further including:
in response to obtaining multiple streams of multimedia data from a target input component, displaying at least one stream of the multimedia data in the first display region of the electronic device, wherein the target input component is a component for collecting or forwarding the at least one stream of the multimedia data; and
identifying objects in the at least one stream of the multimedia data and adding label information to the objects in the first display region, wherein different types of objects are obtained based on different identification models, and the label information is configured to label coordinate information and/or attribute information of the objects.

5. The method according to claim 1, further including:
determining the target multimedia data from the at least one stream of the multimedia data displayed in the first display region based on the first operation, which correspondingly includes one of:
determining a target object from the at least one stream of the multimedia data based on the first operation, and determining multimedia data containing the target object as the target multimedia data;
determining the target object from the at least one stream of the multimedia data based on the first operation, and cropping corresponding multimedia data with corresponding first cropping parameter based on label information of the target object to obtain the target multimedia data;
determining the target object from the at least one stream of the multimedia data based on the first operation, and cropping corresponding multimedia data with corresponding second cropping parameter based on label information and output layout information of the target object to obtain the target multimedia data; and
based on that the first operation is a circle-selection operation of circle-selecting the target object from the at least one stream of the multimedia data, determining multimedia data circle-selected by the circle-selection operation as the target multimedia data.

6. The method according to claim 5, wherein determining the target object from the at least one stream of the multimedia data based on the first operation includes one of:
in response to the first operation is a drag operation of dragging a first object labeled in the first display region from a first position to a second position, determining the first object to be the target object, wherein the second position is outside the first display region;
in response to the first operation is a circle-selection operation performed on the first display region, determining an object circle-selected by the circle-selection operation as the target object;
in response to the first operation is an instruction input operation performed on the electronic device or the first display region of the electronic device, determining an object or region content matching an instruction inputted by the instruction input operation as the target object; and
in response to the first operation is a gesture input operation performed on the electronic device or the first display region of the electronic device, determining an object or region content matching a gesture inputted by the gesture input operation as the target object.

7. The method according to claim 1, wherein generating the target processing logic based on the first operation and the initial processing logic includes one of:
determining display position information of the target multimedia data in the second display region of the electronic device based on the first operation, and processing the initial processing logic based on the display position information and a display parameter of the target multimedia data to obtain the target processing logic; and
determining the display position information of the target multimedia data in the second display region of the electronic device based on the first operation, and processing the initial processing logic based on the display position information and a display output parameter of the target multimedia data to obtain the target processing logic, wherein the display output parameter is obtained based on display configuration information of an output device of target multimedia data for output.

8. The method according to claim 1, further including one of:
switching multimedia data currently displayed in the first display region based on the first operation to determine multiple streams of target multimedia data from multiple streams of multimedia data;
determining a target output mode based on a type of the target multimedia content, and outputting the target multimedia content based on the target output mode; and
determining an output mode of the target multimedia content based on a third operation on the electronic device and outputting the target multimedia content separately or synchronously according to a corresponding type based on determined output mode.

9. The method according to claim 1, wherein outputting the target multimedia content obtained by processing the target multimedia data includes one of:
displaying and outputting the target multimedia content to a same display screen or different display screens based on a type of the target multimedia content;
outputting the target multimedia content to a target output part of the electronic device, wherein the target output part is determined based on attribute information of the target multimedia content;
outputting the target multimedia content to a target application; and
outputting the target multimedia content to an output device having a target connection with the electronic device.

10. An electronic device, comprising:
a memory, configured to store a computer program; and
a processor, coupled to the memory and when the computer program is executed, configured to:
in response to obtaining a first operation performed on a first display region of an electronic device, generate a target processing logic based on the first operation and an initial processing logic, wherein the first display region displays at least one stream of multimedia data obtained by the electronic device, the first operation is configured to determine target multimedia data from the at least one stream of the multimedia data, and the initial processing logic is a processing logic executed by the electronic device to process current multimedia data before obtaining the first operation;
process the target multimedia data based on the target processing logic; and
output target multimedia content obtained by processing the target multimedia data.

11. The electronic device according to claim 10, wherein the processor is further configured to:
in response to obtaining a second operation performed on a second display region of the electronic device, update at least one processing parameter in the target processing logic based on the second operation, wherein the second display region is an interface region for configuring an output parameter of target multimedia content to be outputted.

12. The electronic device according to claim 11, wherein the processor is further configured to perform one of:
determining a configuration option of the second operation, and updating a corresponding processing parameter in the target processing logic based on a configuration parameter corresponding to the configuration option; and
determining operation information of the second operation, generating a corresponding configuration parameter based on the operation information, and updating a corresponding processing parameter in the target processing logic based on the corresponding configuration parameter.

13. The electronic device according to claim 10, wherein the processor is further configured to:
in response to obtaining multiple streams of multimedia data from a target input component, display at least one stream of the multimedia data in the first display region of the electronic device, wherein the target input component is a component for collecting or forwarding the at least one stream of the multimedia data; and
identify objects in the at least one stream of the multimedia data and adding label information to the objects in the first display region, wherein different types of objects are obtained based on different identification models, and the label information is configured to label coordinate information and/or attribute information of the objects.

14. The electronic device according to claim 10, wherein the processor is further configured to:
determine the target multimedia data from the at least one stream of the multimedia data displayed in the first display region based on the first operation, which correspondingly includes one of:
determining a target object from the at least one stream of the multimedia data based on the first operation, and determining multimedia data containing the target object as the target multimedia data;
determining the target object from the at least one stream of the multimedia data based on the first operation, and cropping corresponding multimedia data with corresponding first cropping parameter based on label information of the target object to obtain the target multimedia data;
determining the target object from the at least one stream of the multimedia data based on the first operation, and cropping corresponding multimedia data with corresponding second cropping parameter based on label information and output layout information of the target object to obtain the target multimedia data; and
based on that the first operation is a circle-selection operation of circle-selecting the target object from the at least one stream of the multimedia data, determining multimedia data circle-selected by the circle-selection operation as the target multimedia data.

15. The electronic device according to claim 14, wherein the processor is further configured to perform one of:
in response to the first operation is a drag operation of dragging a first object labeled in the first display region from a first position to a second position, determining the first object to be the target object, wherein the second position is outside the first display region;
in response to the first operation is a circle-selection operation performed on the first display region, determining an object circle-selected by the circle-selection operation as the target object;
in response to the first operation is an instruction input operation performed on the electronic device or the first display region of the electronic device, determining an object or region content matching an instruction inputted by the instruction input operation as the target object; and
in response to the first operation is a gesture input operation performed on the electronic device or the first display region of the electronic device, determining an object or region content matching a gesture inputted by the gesture input operation as the target object.

16. The electronic device according to claim 10, wherein the processor is further configured to perform one of:
determining display position information of the target multimedia data in the second display region of the electronic device based on the first operation, and processing the initial processing logic based on the display position information and a display parameter of the target multimedia data to obtain the target processing logic; and
determining the display position information of the target multimedia data in the second display region of the electronic device based on the first operation, and processing the initial processing logic based on the display position information and a display output parameter of the target multimedia data to obtain the target processing logic, wherein the display output parameter is obtained based on display configuration information of an output device of target multimedia data to be outputted.

17. The electronic device according to claim 10, wherein the processor is further configured to:
switch multimedia data currently displayed in the first display region based on the first operation to determine multiple streams of target multimedia data from multiple streams of multimedia data;
determine a target output mode based on a type of the target multimedia content, and output the target multimedia content based on the target output mode; and
determine an output mode of the target multimedia content based on a third operation on the electronic device and output the target multimedia content separately or synchronously according to a corresponding type based on determined output mode.

18. The electronic device according to claim 10, wherein the processor is further configured to perform one of:
displaying and outputting the target multimedia content to a same display screen or different display screens based on a type of the target multimedia content;
outputting the target multimedia content to a target output part of the electronic device, wherein the target output part is determined based on attribute information of the target multimedia content;
outputting the target multimedia content to a target application; and
outputting the target multimedia content to an output device having a target connection with the electronic device.

19. A non-transitory computer-readable storage medium, containing a computer program for, when executed by a processor, performing:
in response to obtaining a first operation performed on a first display region of an electronic device, generating a target processing logic based on the first operation and an initial processing logic, wherein the first display region displays at least one stream of multimedia data obtained by the electronic device, the first operation is configured to determine target multimedia data from the at least one stream of the multimedia data, and the initial processing logic is a processing logic executed by the electronic device to process current multimedia data before obtaining the first operation;
processing the target multimedia data based on the target processing logic; and
outputting target multimedia content obtained by processing the target multimedia data.

20. The storage medium according to claim 19, wherein the processor is further configured to perform:
in response to obtaining a second operation performed on a second display region of the electronic device, updating at least one processing parameter in the target processing logic based on the second operation, wherein the second display region is an interface region for configuring an output parameter of target multimedia content for output.
